(19) United States
(12) Patent Application Publication
(10) Pub. No.: US 2008/0239141 A1
(43) Pub. Date: Oct. 2, 2008

(54) Digital camera structure

(76) Inventor: Yan Yang, Beijing (CN)

Correspondence Address: Troxell Law Office Pllc, Suite 1404, 5205 Leesburg Pike, Falls Church, VA, 22041, US

(21) Appl. No.: 11/980,745

(22) Filed: Oct. 31, 2007

(30) Foreign Application Priority Data
Dec. 21, 2006 (CN) 200620149595.8

(51) Int. Cl. H04N 5/225

(52) U.S. Cl. 348/373; 348/E05.024

(57) ABSTRACT

The present invention provides a digital camera structure structured from a rotating portion and a fixed portion. The rotating portion is configured with a lens used to capture desired images being filmed. Moreover, a magnetic flux device, attracted to a magnetic flux body of the fixed portion, is held within a housing of the rotating portion. The rotating portion and the fixed portion are made to effectively mutually attract by means of a magnetic force. Moreover, disposition of a retaining cavity on the fixed portion is used to enable the rotating portion to permit multidirectional and large-scale adjustment of the filming angle. The rotating portion can be independently joined to a magnetic piece, magnetism of which enables the rotating portion and the magnetic piece to be attracted to a magnetically attracting device, which better benefits the general user in the convenient use of the lens on the rotating portion.

### BACKGROUND OF THE INVENTION

(a) Field of the Invention

The art of the present invention provides a digital camera structure, and more particularly provides a digital camera that uses the attractive force between a magnetic flux device and a magnetic flux body of a rotating portion and a fixed portion respectively to enable achieving multidirectional and large-scale adjustment of the filming angle of the lens on the fixed portion.

(b) Description of the Prior Art

Referring to FIG. 1, which shows a digital camera of the prior art, which is connected to a computer using a USB connecting line, wherein a digital camera A comprises a camera outer housing A1, a camera lens A2 and a base A3. Moreover, the camera outer housing A1 is fixedly connected to the base A3 by means of a joining mechanism A4, designs of which are manifold, and in order to achieve the objective of multi-angle rotation in three-dimensional space, the joining mechanism A4 requires a relatively large cost expenditure in design and manufacturing. Furthermore, when the camera lens A2 becomes damaged, then the entire digital camera A must be replaced, thereby requiring a substantially high replacement cost expenditure.

Hence, the inventor of the present invention proposes to resolve and surmount existent technical difficulties to eliminate the aforementioned shortcomings of prior art.

### SUMMARY OF THE INVENTION

The art of the present invention provides a digital camera structure, and more particularly provides a digital camera that uses the attractive force between a magnetic flux device and a magnetic flux body of a rotating portion and a fixed portion respectively to enable achieving multidirectional and large-scale adjustment of the filming angle of the lens on the fixed portion, and achieve convenient fixing effectiveness.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of the prior art.

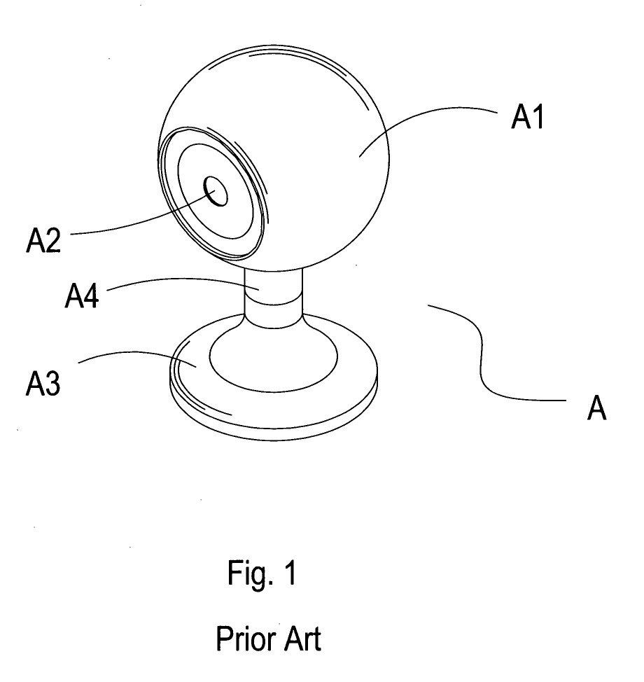

FIG. 2 shows an elevational view of the present invention.

FIG. 3 shows an exploded elevational view of the present invention.

FIG. 4 shows a schematic view (1) of an embodiment according to the present invention.

FIG. 5 shows a schematic view (2) of an embodiment according to the present invention.

FIG. 6 shows a schematic view (3) of an embodiment according to the present invention.

FIG. 7 shows a schematic view (4) of an embodiment according to the present invention.

### DETAILED DESCRIPTION OF THE PREFERRED EMBODIMENTS

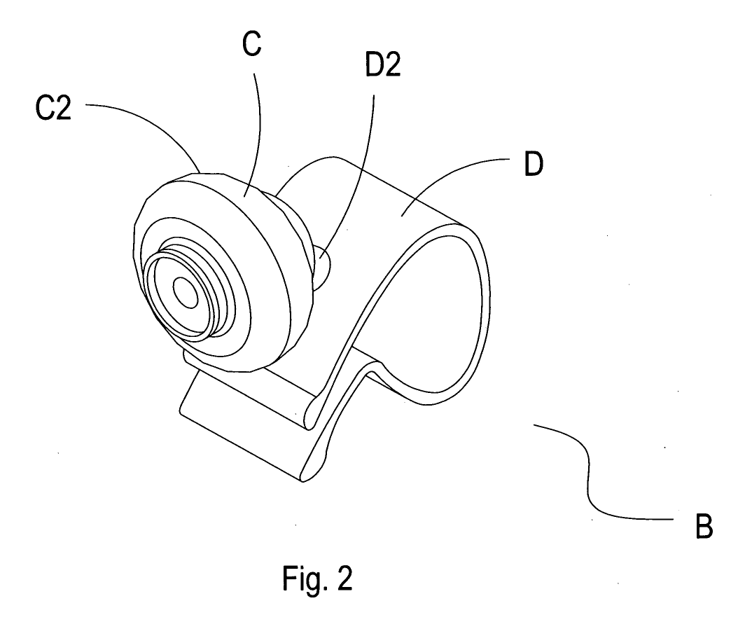

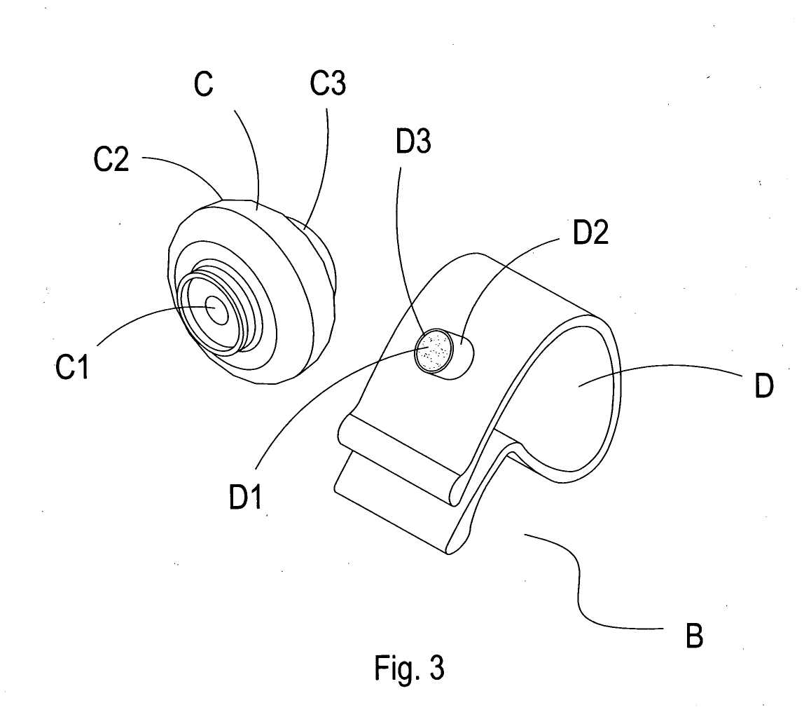

The present invention provides a digital camera structure, as depicted in FIG. 2 and FIG. 3, which show a digital camera B structured to comprise a rotating portion C and a fixed portion D, wherein the rotating portion C comprises a lens C1, which is used to capture desired images being filmed Moreover, a magnetic flux device C3 extends from a housing C2, and the magnetic flux device C3 is attracted to a magnetic flux body D1 of the fixed portion D. The magnetic flux body D1 is held within a housing D2, and the shape of the rotating portion C corresponds to a retaining cavity D3 of the fixed portion D, thereby enabling the rotating portion C and the fixed portion D to effectively mutually attract by means of a magnetic force; moreover, disposition of the retaining cavity D3 is used to enable the rotating portion C to permit multidirectional and large-scale adjustment of the filming angle on the fixed portion D, and achieve convenient fixing effectiveness.

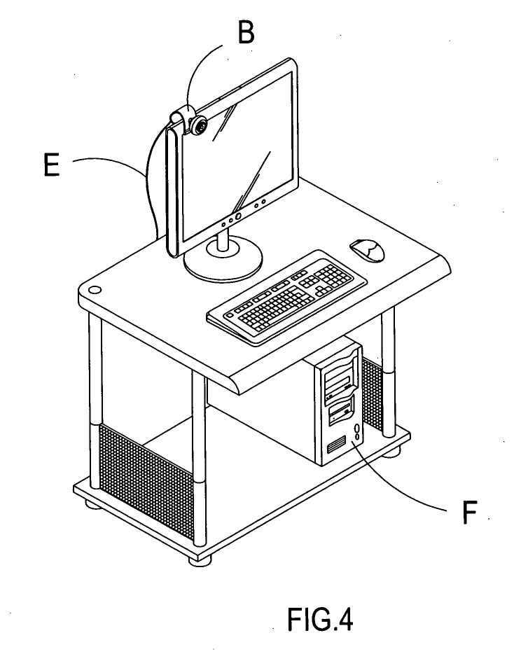

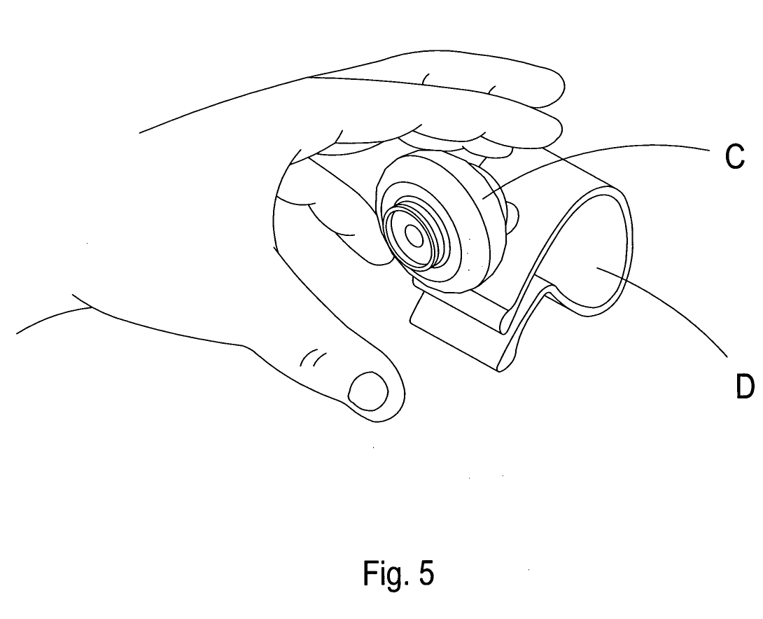

An embodiment of the present invention provides the digital camera structure, as depicted in FIG. 3, FIG. 4 and FIG. 5, wherein the digital camera B can be connected to a computer F using a USB connecting line E, and the user can use the lens C1 of the rotating portion C to capture desired images being filmed, and transmit the images to the computer F via the USB connecting line E. If the material of the magnetic flux device C3 extending from the housing C2 of the rotating portion C is iron, then the magnetic flux body D1 attracting the magnetic flux device C3 is a magnet; on the other hand, if the magnetic flux device C3 is a magnet, then the material of the magnetic flux body D1 is iron. Furthermore, the lens C1 is further configured as a CCD (Charge Coupled Device) lens, a CMOS (Complementary Metal-Oxide Semiconductor) lens and related photographic lens.

The magnetic flux body D1 is held within the housing D2 of the fixed portion D, and the fixed portion D is additionally configured with the circular concave retaining cavity D3 that corresponds to the spherical form of the rotating portion C, thereby enabling multi-angle rotation of the rotating portion C loaded on the fixed portion D on the retaining cavity D3, and effectively resolving the cost expenditure requirement for a complicated joining mechanism to join the rotating portion C to the fixed portion D. Moreover, multidirectional and large-scale adjustment of the filming angle on the fixed portion D is achieved, as well as convenient fixing effectiveness.

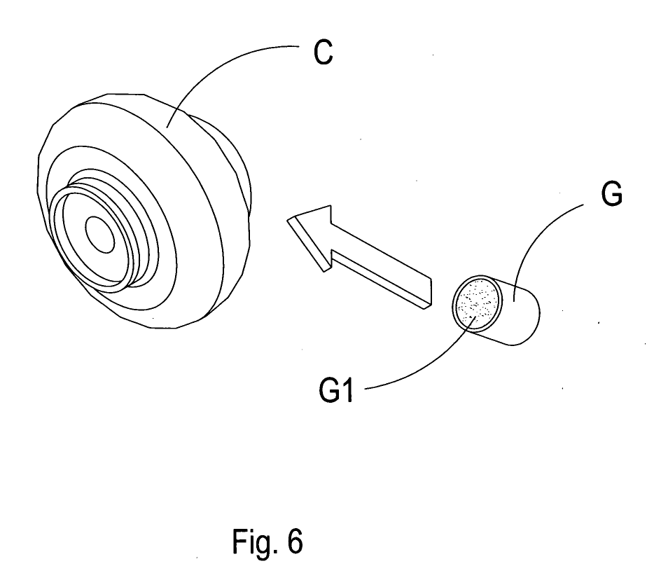

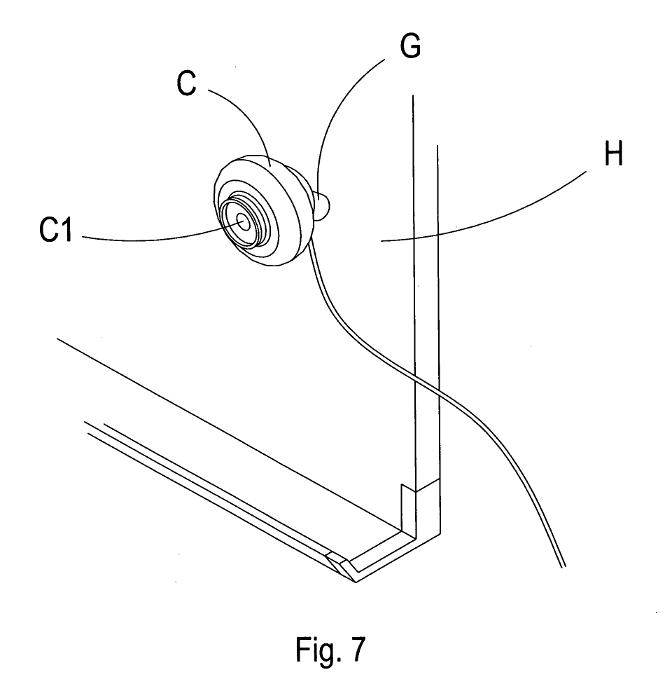

Referring to FIG. 6 and FIG. 7, the rotating portion C can be independently joined to a magnetic piece G, which further comprises a cavity G1 able to accommodate the rotating portion C, and the cavity G1 bears the weight of the rotating portion C and enables multidirectional and large-scale rotation of the rotating portion C on the magnetic piece G. The rotating portion C can use magnetism of the magnetic piece G to further enable the rotating portion C and the magnetic piece G to be attracted to a magnetically attracting device H, thereby enabling multifarious disposition of the rotating portion C by means of the magnetic piece G, which, moreover, better benefits the general user in the convenient use of the lens C1 on the rotating portion C.

In order to better explicitly disclose advancement and practicability of the present invention, a comparison with prior art is described hereinafter:

Shortcomings of Prior Art

1. Requires a complicated joining mechanism to join the camera housing to the base.

2. Because of shortcoming 1, expenditure on design and manufacturing is substantially greater.

3. Only enables up and down adjustment of the filming angle.

4. When damaged, the entire digital camera must be replaced.

5. Because of shortcoming 4, replacement cost expenditure is increased.

Advantages of the Present Invention

1. Does not require a complicated joining mechanism to join the rotating portion C to the fixed portion D.

2. Because of shortcoming 1, expenditure on design and manufacturing is reduced.

3. Enables multidirectional and large-scale adjustment of the filming angle.

4. When damaged, only the visibly damaged portions need to be replaced.

5. Because of shortcoming 4, replacement cost expenditure is reduced.

6. Enables convenient multifarious installation, and better benefits the general user in convenience of use.

7. Provided with advancement and practicability.

8. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A digital camera structure, wherein a digital camera comprises a rotating portion, the rotating portion being configured with a lens; a magnetic flux device is located on the rotating portion, and the magnetic flux device is attracted to a magnetic flux body of a fixed portion; wherein means of mutual attraction between the magnetic flux device and the magnetic flux body is used, thereby enabling the rotating portion to permit multidirectional and large-scale adjustment of the filming angle on the fixed portion, and achieve convenient fixing effectiveness.

2. The digital camera structure according to claim 1, wherein the fixed portion comprises a retaining cavity able to accommodate the rotating portion, the retaining cavity bears the weight of the rotating portion and enables the rotating portion to permit multidirectional and large-scale adjustment on the fixed portion.

3. The digital camera structure according to claim 1, wherein the rotating portion is independently joined to a magnetic piece, and the magnetic piece further comprises a cavity able to accommodate the rotating portion, the cavity bears the weight of the rotating portion and enables multidirectional and large-scale rotation of the rotating portion on the magnetic piece.

4. The digital camera structure according to claim 3, wherein the rotating portion uses magnetism of the magnetic piece to further enable the rotating portion and the magnetic piece to be attracted to a magnetically attracting device, thereby enabling multifarious disposition of the rotating portion, which, moreover, better benefits the general user in the convenient use of the lens on the rotating portion.

5. The digital camera structure according to claim 1, wherein material of the magnetic flux device is a magnet, and material of the magnetic flux body is iron.

6. The digital camera structure according to claim 1, wherein material of the magnetic flux device is iron, and material of the magnetic flux body is a magnet.

7. The digital camera structure according to claim 1, wherein the lens is further configured as a CCD (Charge Coupled Device) lens, a CMOS (Complementary Metal-Oxide Semiconductor) lens and related photographic lens.
